(19) United States
(12) Patent Application Publication
(10) Pub. No.: US 2025/0095207 A1
(43) Pub. Date: Mar. 20, 2025

(54) IMAGE QUALITY (IQ) IMPROVEMENT

(71) Applicant: QUALCOMM Incorporated, San Diego, CA (US)

(72) Inventors: Prakasha NAYAK, Parkala (IN); Nikhil VERMA, Bangalore (IN); Mukesh PAREEK, San Diego, CA (US)

(21) Appl. No.: 18/467,492

(22) Filed: Sep. 14, 2023

(51) Int. Cl. G06T 7/90; H04N 23/71

(52) U.S. Cl. CPC G06T 7/90; H04N 23/71; G06T 2207/10024; G06T 2207/10144; G06T 2207/20208

(57) ABSTRACT

Disclosed are techniques for providing improvements for red green blue white (RGBW) images and red yellow blue (RYYB) images. For example, a computing device can obtain first image frame(s) of a scene captured by one or more RGBW sensors with a first exposure at a sensor frame rate. The computing device can obtain second image frame(s) of the scene captured by the RGBW sensor(s) with a second exposure at the sensor frame rate. The second exposure is lower than the first exposure. The computing device can blend red green blue (RGB) components of each image frame of the first image frame(s) with RGB components of a respective adjacent second image frame of the second image frame(s) to produce blended image frame(s). The computing device can apply a white component of each image frame of the second image frame(s) to a respective blended image frame of the blended image frame(s).

### FIELD

The present disclosure generally relates to image processing. For example, aspects of the present disclosure are related to systems and techniques for image quality (IQ) improvement, including IQ improvement for red green blue white (RGBW) images and red yellow blue (RYYB) images.

### BACKGROUND

A camera is a device that receives light and captures image frames, such as still images or video frames, using an image sensor. Cameras may include one or more processors, such as image signal processors (ISPs), that can process one or more image frames captured by an image sensor. For example, a raw image frame captured by an image sensor can be processed by an image signal processor (ISP) to generate a final image. Cameras can be configured with a variety of image capture and image processing settings to alter the appearance of an image. Some camera settings are determined and applied before or while an image is captured, such as ISO, exposure time (also referred to as exposure duration), aperture size, f/stop, shutter speed, focus, and gain, among others. Moreover, some camera settings can be configured for post-processing of an image, such as alterations to a contrast, brightness, saturation, sharpness, levels, curves, and colors, among others.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for improving RGBW and RYYB image quality. According to at least one example, an apparatus for processing one or more images is provided. The apparatus comprising at least one memory and at least one processor coupled to the at least one memory and configured to: obtain one or more first image frames of a scene captured by one or more red green blue white (RGBW) sensors with a first exposure at a sensor frame rate; obtain one or more second image frames of the scene captured by the one or more RGBW sensors with a second exposure at the sensor frame rate, wherein the second exposure is lower than the first exposure; blend red green blue (RGB) components of each image frame of the one or more first image frames with RGB components of a respective adjacent second image frame of the one or more second image frames to produce one or more blended image frames; and apply a white component of each image frame of the one or more second image frames to a respective blended image frame of the one or more blended image frames.

In another illustrative example, a method for image processing is provided. The method includes: capturing, by one or more red green blue white (RGBW) sensors, one or more first image frames of a scene with a first exposure at a sensor frame rate; capturing, by the one or more RGBW sensors, one or more second image frames of the scene with a second exposure at the sensor frame rate, wherein the second exposure is lower than the first exposure; blending red green blue (RGB) components of each image frame of the one or more first image frames with RGB components of a respective adjacent second image frame of the one or more second image frames to produce one or more blended image frames; and applying a white component of each image frame of the one or more second image frames to a respective blended image frame of the one or more blended image frames.

In another illustrative example, a non-transitory computer-readable storage medium is provided that includes instructions stored thereon which, when executed by at least one processor, causes the at least one processor to: obtain one or more first image frames of a scene captured by one or more red green blue white (RGBW) sensors with a first exposure at a sensor frame rate; obtain one or more second image frames of the scene captured by the one or more RGBW sensors with a second exposure at the sensor frame rate, wherein the second exposure is lower than the first exposure; blend red green blue (RGB) components of each image frame of the one or more first image frames with RGB components of a respective adjacent second image frame of the one or more second image frames to produce one or more blended image frames; and apply a white component of each image frame of the one or more second image frames to a respective blended image frame of the one or more blended image frames.

In another illustrative example, an apparatus for processing one or more images is provided. The apparatus includes: means for capturing, by one or more red green blue white (RGBW) sensors, one or more first image frames of a scene with a first exposure at a sensor frame rate; means for capturing, by the one or more RGBW sensors, one or more second image frames of the scene with a second exposure at the sensor frame rate, wherein the second exposure is lower than the first exposure; means for blending red green blue (RGB) components of each image frame of the one or more first image frames with RGB components of a respective adjacent second image frame of the one or more second image frames to produce one or more blended image frames; and means for applying a white component of each image frame of the one or more second image frames to a respective blended image frame of the one or more blended image frames.

In another illustrative example, an apparatus for processing one or more images is provided. The apparatus includes at least one memory and at least one processor coupled to the at least one memory and configured to: obtain one or more first image frames of a scene captured by one or more red yellow blue (RYYB) sensors with a first exposure at a sensor frame rate; obtain one or more second image frames of the scene captured by the one or more RYYB sensors with a second exposure at the sensor frame rate, wherein the second exposure is lower than the first exposure; blend at least one color component of each image frame of the one or more first image frames with at least one color component of a respective adjacent second image frame of the one or more second image frames to produce one or more blended image frames; and generate at least one output frame comprising one or more color components from the one or more blended image frames and at least one additional color component from each image frame of the one or more first image frames.

In another illustrative example, a method for processing one or more images is provided. The method includes: obtaining one or more first image frames of a scene captured by one or more red yellow blue (RYYB) sensors with a first exposure at a sensor frame rate; obtaining one or more second image frames of the scene captured by the one or more RYYB sensors with a second exposure at the sensor frame rate, wherein the second exposure is lower than the first exposure; blending at least one color component of each image frame of the one or more first image frames with at least one color component of a respective adjacent second image frame of the one or more second image frames to produce one or more blended image frames; and generating at least one output frame comprising one or more color components from the one or more blended image frames and at least one additional color component from each image frame of the one or more first image frames.

In another illustrative example, a non-transitory computer-readable storage medium is provided that includes instructions stored thereon which, when executed by at least one processor, causes the at least one processor to: obtain one or more first image frames of a scene captured by one or more red yellow blue (RYYB) sensors with a first exposure at a sensor frame rate; obtain one or more second image frames of the scene captured by the one or more RYYB sensors with a second exposure at the sensor frame rate, wherein the second exposure is lower than the first exposure; blend at least one color component of each image frame of the one or more first image frames with at least one color component of a respective adjacent second image frame of the one or more second image frames to produce one or more blended image frames; and generate at least one output frame comprising one or more color components from the one or more blended image frames and at least one additional color component from each image frame of the one or more first image frames.

In another illustrative example, an apparatus for processing one or more images is provided. The apparatus includes: means for obtaining one or more first image frames of a scene captured by one or more red yellow blue (RYYB) sensors with a first exposure at a sensor frame rate; means for obtaining one or more second image frames of the scene captured by the one or more RYYB sensors with a second exposure at the sensor frame rate, wherein the second exposure is lower than the first exposure; means for blending at least one color component of each image frame of the one or more first image frames with at least one color component of a respective adjacent second image frame of the one or more second image frames to produce one or more blended image frames; and means for generating at least one output frame comprising one or more color components from the one or more blended image frames and at least one additional color component from each image frame of the one or more first image frames.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example architecture of an image processing system, in accordance with some examples of the present disclosure.

FIG. 2 illustrates multiple images with different exposures used to create a fused high dynamic range (HDR) image, in accordance with some examples of the present disclosure.

FIG. 3 is a block diagram of an example device that may employ the disclosed systems and techniques, in accordance with some examples of the present disclosure.

FIG. 4 is a block diagram showing the operation of an image signal processor pipeline, in accordance with some examples of the present disclosure.

FIG. 5 is a block diagram showing an example of RGBW image processing, in accordance with some examples of the present disclosure.

FIG. 6 is flow chart showing an example of a process for RGBW image processing, in accordance with some examples of the present disclosure.

FIG. 7 is graph showing an example of capturing and processing image frames using an RGBW sensor over time, in accordance with some examples of the present disclosure.

FIG. 8 is graph showing another example of capturing and processing image frames using an RGBW sensor over time, in accordance with some examples of the present disclosure.

FIG. 9 is a diagram illustrating an example of an RGB pattern for capturing an RGB frame and an example of an RYYB pattern for capturing an RYYB frame, in accordance with some examples of the present disclosure.

FIG. 10 is a diagram illustrating an example of generating an RGB frame based on a full-resolution RYYB frame, in accordance with some examples of the present disclosure.

FIG. 11 is a diagram illustrating an example of enhancing RYYB frames in bright light scenarios, in accordance with some examples of the present disclosure.

FIG. 12 is a diagram illustrating an example of enhancing RYYB frames in low light scenarios, in accordance with some examples of the present disclosure.

FIG. 13 is a diagram illustrating an example of varying Sensor Analog Gain (ISO gain) for frames, in accordance with some examples of the present disclosure.

FIG. 14 is a diagram illustrating an example of processing frames in a low-light scene, in accordance with some examples of the present disclosure.

FIG. 15 is a flow chart illustrating an example of a process for image processing, in accordance with aspects of the present disclosure.

FIG. 16 is a block diagram illustrating an example of a computing system, which may be employed by the disclosed systems and techniques for improving RGBW image quality, in accordance with aspects of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with camera hardware to capture image frames, such as still images and/or video frames, for consumption. For example, an electronic device can include a camera to allow the electronic device to capture a video or image of a scene, a person, an object, etc. A camera is a device that receives light and captures image frames (e.g., still images or video frames) using an image sensor. In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, an electronic device implementing a camera can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Moreover, cameras can be configured with a variety of image capture and image processing settings to alter the appearance of an image. Some camera settings can be determined and applied before or while an image is captured, such as ISO, exposure time (also referred to as exposure duration), aperture size, f/stop, shutter speed, focus, and gain, among others. Some camera settings can be configured for post-processing of an image, such as alterations to a contrast, brightness, saturation, sharpness, levels, curves, and colors, among others. In some examples, a camera can be configured with certain settings to adjust the exposure of an image captured by the camera.

In photography, the exposure of an image captured by a camera refers to the amount of light per unit area that reaches a photographic film, or in modern cameras, an electronic image sensor. The exposure is based on certain camera settings such as, for example, shutter speed, exposure time, and/or lens aperture, as well as the luminance of the scene being photographed. Many cameras are equipped with an automatic exposure or “auto exposure” mode, where the exposure settings (e.g., shutter speed, exposure time, lens aperture, etc.) of the camera may be automatically adjusted to match, as closely as possible, the luminance of a scene or subject being photographed. In some cases, an automatic exposure control (AEC) engine can perform AEC to determine exposure settings for an image sensor.

In photography and videography, a technique called high dynamic range (HDR) allows the dynamic range of image frames captured by a camera to be increased beyond the native capability of the camera. In this context, a dynamic range refers to the range of luminosity between the brightest area and the darkest area of the scene or image frame. For example, a high dynamic range means there is large variation in light levels within a scene or an image frame. HDR can involve capturing multiple image frames of a scene with different exposures and combining captured image frames with the different exposures into a single image frame. The combination of image frames with different exposures can result in an image with a dynamic range higher than that of each individual image frame captured and combined to form the HDR image frame. For example, the electronic device can create a high dynamic range scene by fusing two or more exposure frames into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

Currently, cameras are typically implemented with red, green, blue (RGB) sensors for capturing images. These RGB sensors include RGB sensor arrays. Red, green, blue, white (RGBW) technology adds an additional white (W) pixel to an RGB sensor array to form an RGBW sensor. The addition of the white pixel into the RGB sensor array can allow for the camera to capture high-definition images, especially for low light, dim, and dull surroundings.

Since RGBW sensors have a unique pixel arrangement including white pixels, RGBW sensors are much more light-sensitive, as compared to RGB sensors. The addition of the white pixels to the RGB arrays allows for the prevention of distortion of the original RGB primary colors in images. The benefit of RGBW technology lies in the fact that with the inclusion of the white pixels, an improved (e.g., 1.7 times better) light sensitivity can be achieved. This improved light sensitivity can allow for an improvement in the overall brightness of the camera images and a reduction in color distortions in the images.

However, RGBW sensors can produce noisy images in scenes with bright light scenarios because the exposing for the white pixel can underexpose the RGB pixels. During image processing of an image captured by an RGBW sensor, the RGBW pattern in a raw format can be converted into to an RGB domain, which can then be transformed into a YUV domain. In the YUV domain, the W component (signal) can be added to a Y channel of the RGB image to reach a higher luma. U channel and V channel of the YUV domain can be normalized by using the W component, such as by using a factor of (Y+W) Y, to adjust the luminance and maintain the color saturation.

During a bright light scene scenario, the W component will be dominant, which can negatively affect the overall color saturation in an image (e.g., the colors in the image erroneously appear over saturated). As such, dim RGB pixels can suffer from strong crosstalk (e.g., interference) from the bright W pixels. This interference can cause an oversaturation of the colors in an image. As such, a technique for improving RGBW image quality in bright light scenarios can be beneficial.

Red yellow blue (RYYB) images are another alternative to RGB images. Image sensors that capture RYYB images can use the same pattern as RGB image sensors, but with the green filters replaced by yellow filters on the pattern (e.g., replacing RGGB with RYYB). Using yellow instead of green can make the yellow pixels more sensitive to light as compared to green pixels, which can lead to enhancements in the captured images. However, the green intensity at those pixels has to be calculated by subtracting an estimate of red intensity (e.g., interpolated from adjacent red pixels) from the yellow to obtain the green color, which may slightly increase noise and reduce sharpness in the green colors. Furthermore, for an RYYB sensor when capturing images in scenes with bright lighting, the yellow pixels may have more cross talk. When capturing images in low-light scenes, the blue pixels may have more cross talk. Also, for an RYYB sensor, dark patches may have higher luma noise even with higher SNR. White balance applied to RYYB images may also boost blue and/or red channel noise, such as for blue under low light conditions.

Systems, apparatuses, methods (also referred to as processes), and computer-readable media (collectively referred to herein as “systems and techniques”) are described herein for improving RGBW and RYYB image quality. For instance, the systems and techniques described herein can enhance the color saturation of images obtained by RGBW and RYYB sensors in various lighting scenarios, such as bright light and/or low light scenes. In one or more examples, the system and techniques may use different sensor frame rate modes (e.g., 60 frames per second (fps) and 30 fps modes) and may vary the exposure during the capturing of image frames. Using RGBW frames as an example, the systems and techniques can perform blending of RGB components of the image frames along with using a W component from a low exposure image frame to achieve a reduction in noise and an improvement in dynamic range.

In one or more examples, during a bright light scene scenario, one image frame (e.g., a first image frame) with normal exposure can be captured, and one image frame (e.g., a second image frame) with a low and/or reduced exposure (e.g., to prevent the W component from saturating) can be captured. The RGB components from the normal exposure image frame and the W component from low exposure image frame can help to control the color saturation in the image. Stronger RGB signals (components) with lower noise and better dynamic range can help to improve the color saturation in bright light scenarios. Saturation information from the W pixels from normal exposure image frames can be used to determine an exposure value for the subsequent low and/or reduced exposure image frame.

As noted previously, for an RYYB sensor during bright light scenarios, yellow pixels has more cross talk. In some examples, during bright light scenarios, the systems and techniques can increase a frame rate from a normal-operating frame rate (e.g., increase to 60 fps when operating at a normal-operating frame rate of 30 fps. While operating at the increased frame rate (e.g., 60 fps), the systems and techniques can capture a first frame at a first exposure and a second frame with a second exposure that is reduced with respect to the first exposure. The systems and techniques can take blue pixels from the first frame, and can blend Y and R pixels from both the first and second frames. Such a solution can, for example, help to reduce the delta (e.g., for the R pixels) and improve the SNR for the G pixels. In some cases, the systems and techniques can blend R pixels for better dynamic range.

As also described previously, for an RYYB sensor during low light scenarios, blue pixels have more cross talk. In some examples, during low light scenarios, the systems and techniques can increase a frame rate from a normal-operating frame rate (e.g., increase to 60 fps when operating at a normal-operating frame rate of 30 fps. While operating at the increased frame rate (e.g., 60 fps), the systems and techniques can capture a first frame at a first exposure and a second frame with a second exposure that is reduced with respect to the first exposure. The systems and techniques can take Y and R pixels from the first frame, and can blend B pixels from both the first and second frames. Such a solution can, for example, help to improve the B signal and improve the SNR for the B pixels. In some cases, the systems and techniques can blend R and Y pixels for better dynamic range.

Additional aspects of the present disclosure are described in more detail below with respect to the figures.

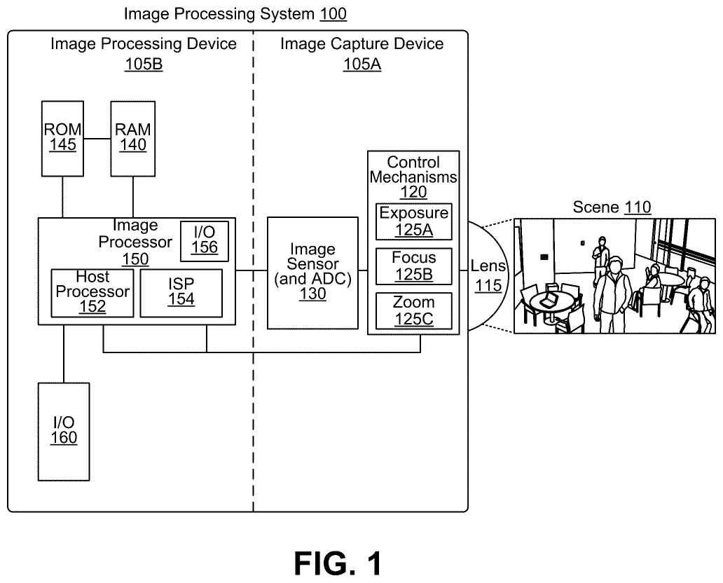

FIG. 1 is a block diagram illustrating an example architecture of an image processing system 100. The image processing system 100 includes various components that are used to capture and process images, such as an image of a scene 110. The image processing system 100 can capture image frames (e.g., still images or video frames). In some cases, the lens 115 and image sensor 130 can be associated with an optical axis. In one illustrative example, the photosensitive area of the image sensor 130 (e.g., the photodiodes) and the lens 115 can both be centered on the optical axis. In one or more examples, the image sensor 130 may be or may include an RGBW sensor.

In some examples, the lens 115 of the image processing system 100 faces a scene 110 and receives light from the scene 110. The lens 115 bends incoming light from the scene toward the image sensor 130. The light received by the lens 115 then passes through an aperture of the image processing system 100. In some cases, the aperture (e.g., the aperture size) is controlled by one or more control mechanisms 120. In other cases, the aperture can have a fixed size.

The one or more control mechanisms 120 can control exposure, focus, and/or zoom based on information from the image sensor 130 and/or information from the image processor 150. In some cases, the one or more control mechanisms 120 can include multiple mechanisms and components. For example, the control mechanisms 120 can include one or more exposure control mechanisms 125A, one or more focus control mechanisms 125B, and/or one or more zoom control mechanisms 125C. The one or more control mechanisms 120 may also include additional control mechanisms besides those illustrated in FIG. 1. For example, in some cases, the one or more control mechanisms 120 can include control mechanisms for controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting the focus. In some cases, additional lenses may be included in the image processing system 100. For example, the image processing system 100 can include one or more microlenses over each photodiode of the image sensor 130. The microlenses can each bend the light received from the lens 115 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and the focus control mechanism 125B.

The exposure control mechanism 125A of the control mechanisms 120 can obtain an exposure setting. In some cases, the exposure control mechanism 125A stores the exposure setting in a memory register. Based on the exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, the image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

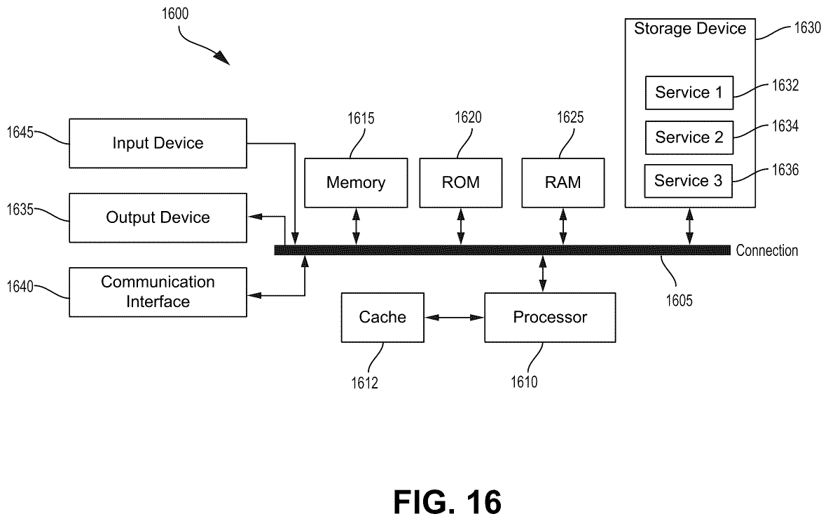

The image processor 150 may include one or more processors, such as one or more image signal processors (ISPs) (including ISP 154), one or more host processors (including host processor 152), and/or one or more of any other type of processor discussed with respect to the computing device architecture 1600 of FIG. 16. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140, read-only memory (ROM) 145, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or any combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image processing system 100 and one or more peripheral devices, over which the image processing system 100 may receive data from the one or more peripheral device and/or transmit data to the one or more peripheral devices. The I/O devices 160 may include one or more wireless transceivers that enable a wireless connection between the image processing system 100 and one or more peripheral devices, over which the image processing system 100 may receive data from the one or more peripheral device and/or transmit data to the one or more peripheral devices. The peripheral devices may include any of the previously-discussed types of the I/O devices 160 and may themselves be considered I/O devices 160 once they are coupled to the ports, jacks, wireless transceivers, or other wired and/or wireless connectors.

In some cases, the image processing system 100 may be a single device. In some cases, the image processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A. In some examples, the image processing system 100 can include one or more wireless transceivers for wireless communications, such as cellular network communications, 802.11 wi-fi communications, wireless local area network (WLAN) communications, or some combination thereof.

The image processing system 100 can be part of, or implemented by, a single computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

The image capture device 105A and the image processing device 105B can be part of the same electronic device or different electronic devices. In some implementations, the image capture device 105A and the image processing device 105B can be different devices. For instance, the image capture device 105A can include a camera device and the image processing device 105B can include a computing device, such as a mobile device, a desktop computer, a smartphone, a smart television, a game console, or other computing device.

While the image processing system 100 is shown to include certain components, one of ordinary skill will appreciate that the image processing system 100 can include more components than those shown in FIG. 1. The components of the image processing system 100 can include software, hardware, or one or more combinations of software and hardware. For example, in some implementations, the components of the image processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image processing system 100.

In some examples, the computing device architecture 1600 shown in FIG. 16 and further described below can include the image processing system 100, the image capture device 105A, the image processing device 105B, or a combination thereof.

In some examples, the image processing system 100 can create an HDR image using multiple image frames with different exposures. For example, the image processing system 100 can create an HDR image using a short exposure (SE) image, a medium exposure (ME) image, and a long exposure (LE) image. As another example, the image processing system 100 can create an HDR image using an SE image and an LE image. In some cases, the image processing system 100 can write the different image frames from one or more camera frontend engines to a memory device, such as a DDR memory device or any other memory device. A post-processing engine can then retrieve the image frames and fuse (e.g., merge, combine) them into a single image. As previously explained, the different write and read operations used to create the HDR image can result in significant power and bandwidth consumption.

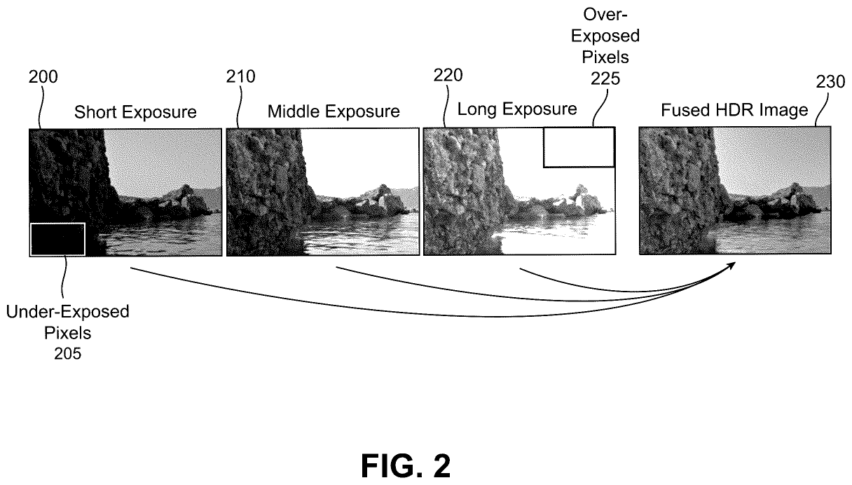

As previously explained, when creating an HDR image, over-exposed pixels of a long exposure image and under-exposed pixels of a short exposure image generally do not contribute to the final HDR image produced by the image processing system 100. For example, FIG. 2 illustrates multiple images with different exposures used to create a fused HDR image (e.g., HDR image 230). In particular, FIG. 2 shows a short exposure image 200, a medium exposure image 210, a long exposure image 220, and an HDR image 230 generated by combining or fusing together the short exposure image 200, the medium exposure image 210, and the long exposure image 220. The short exposure image 200 includes under-exposed pixels 205, and the long exposure image 220 includes over-exposed pixels 225.

As shown in FIG. 2, the under-exposed pixels 205 in the short exposure image 200 and the over-exposed pixels 225 in the long exposure image 220 do not contribute to the pixels of the HDR image 230. In some cases, when creating the HDR image 230, the image processing system 100 writes the under-exposed pixels 205 in the short exposure image 200 and the over-exposed pixels 225 in the long exposure image 220 from a camera frontend engine(s) of the image processing system 100 to a memory device, reads them back (e.g., via an offline image processing engine) from the memory device, and processes the pixels of the three images (e.g., short exposure image 200, middle exposure image 210, and long exposure image 220) to create the HDR image 230. The operations to read, write, and process the under-exposed pixels 205 in the short exposure image 200 and the over-exposed pixels 225 in the long exposure image 220 contribute to the overall power and bandwidth consumption of the image processing system 100 when creating the HDR image 230, even though such pixels do not contribute to the HDR image 230.

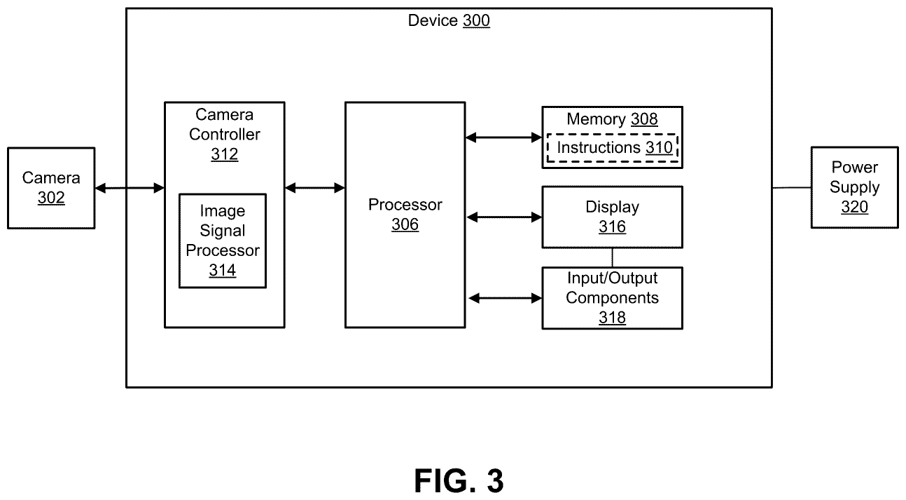

FIG. 3 is a block diagram of an example device 300 that may employ the systems and techniques for improving RGBW image quality. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like. In one or more examples, the ISP 314 can run a 3A algorithm to determine 3A parameters (e.g., 3A statistics). The 3A parameters can include, but are not limited to, parameters associated with AF, parameters associated with AWB, and/or parameters associated with AE.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

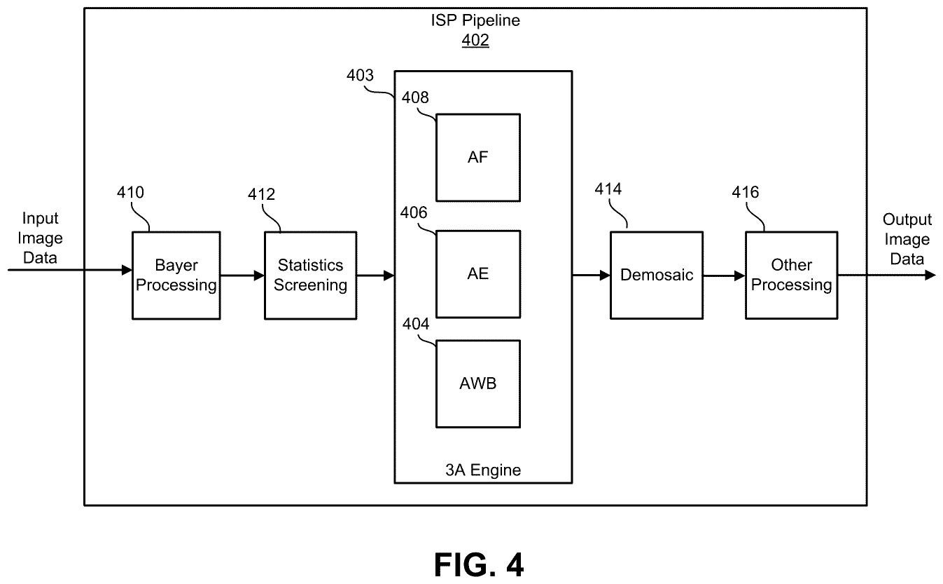

FIG. 4 is a block diagram showing the operation of an image signal processing pipeline 402 of an image signal processor (e.g., the ISP 314). For example, the ISP 314 may be configured to execute the image signal processing pipeline 402 to process input image data. The ISP 314 may receive the input image data from camera 302 of FIG. 3 and/or an image sensor (not shown) of camera 302. In some examples, such as shown in FIG. 4, the input image data may include color data of the image/frame and/or any other data (e.g., depth data). In the example of FIG. 4, the color data received for the input image data may be in a Bayer format. Rather than capturing red (R), green (G), and blue (B) values for each pixel of an image, image sensors (e.g., an image sensor of camera 302) may use a Bayer filter mosaic (or more generally, a color filter array (CFA)), where each photosensor of a digital image sensor captures a different one of the RGB colors. One example of a filter pattern for a Bayer filter mosaic may include 50% green filters, 25% red filters, and 25% blue filters.

Bayer processing unit 410 may perform one or more initial processing techniques on the raw Bayer data received by ISP 314, including, for example, subtraction, rolloff correction, bad pixel correction, black level compensation, and/or denoising.

Stats screening process 412 may determine Bayer grade or Bayer grid (BG) statistics of the received input image data. In some examples, BG statistics may include a red color to green color ratio (R/G) (which may indicate whether a red tinting exists and the magnitude of the red tinting that may exist in an image) and/or a blue color to green color ratio (B/G) (which may indicate whether a blue tinting exists and the magnitude of the blue tinting that may exist in an image). For example, the (R/G) for an image or a portion/region of an image may be depicted by equation (1) below:

$$R / G = \frac{{\sum }_{n = 1}^{N} Red ( n )}{{\sum }_{n = 1}^{N} Green ( n )} \qquad ( 1 )$$

where the image or a portion/region of the image includes pixels 1-N, each pixel n includes a red value Red (n), a blue value Blue (n), or a green value Green (n) in an RGB space. The (R/G) is the sum of the red values for the red pixels in the image divided by the sum of the green values for the green pixels in the image. Similarly, the (B/G) for the image or a portion/region of the image may be depicted by equation (2) below:

$$B / G = \frac{{\sum }_{n = 1}^{N} Blue ( n )}{{\sum }_{n = 1}^{N} Green ( n )} \qquad ( 2 )$$

In some other example implementations, a different color space may be used, such as Y′UV, with chrominance values UV indicating the color, and/or other indications of a tinting or other color temperature effect for an image may be determined.

AWB module and/or process 404 may analyze information relating to the received image data to determine an illuminant of the scene, from among a plurality of possible illuminants, and may determine an AWB gain to apply to the received image and/or a subsequent image based on the determined illuminant. White balance is a process used to try to match colors of an image with a user's perceptual experience of the object being captured. As an example, the white balance process may be designed to make white objects actually appear white in the processed image and gray objects actually appear gray in the processed image.

An illuminant may include a lighting condition, a type of light, etc. of the scene being captured. In some examples, a user of an image capture device (e.g., such as device 300 of FIG. 3) may select or indicate an illuminant under which an image was captured. In other examples, the image capture device itself may automatically determine the most likely illuminant and perform white balancing based on the determined illuminant (e.g., lighting condition). In order to better render the colors of a scene in a captured image or video, an AWB algorithm on a device and/or camera may attempt to determine the illuminants of the scene and set/adjust the white balance of the image or video accordingly.

Device 300, during the AWB process 404 (e.g., within a 3A engine 403, which may run a 3A algorithm), may determine or estimate a color temperature for a received frame (e.g., image). The color temperature may indicate a dominant color tone for the image. The true color temperature for a scene being captured in a video or image is the color of the light sources for the scene. If the light is radiation emitted from a perfect blackbody radiator (theoretically ideal for all electromagnetic wavelengths) at a particular color temperature (represented in Kelvin (K)), and the color temperatures are known, then the color temperature for the scene is known. For example, in a Commission Internationale de l'éclairage (CIE) defined color space (from 1931), the chromaticity of radiation from a blackbody radiator with temperatures from 1,000 to 20,000 K is the Planckian locus. Colors on the Planckian locus from approximately 2,000 K to 20,000 K are considered white, with 2,000 K being a warm or reddish white and 20,000 K being a cool or bluish white. Many incandescent light sources include a Planckian radiator (tungsten wire or another filament to glow) that emits a warm white light with a color temperature of approximately 2,400 to 3,100 K.

However, other light sources, such as fluorescent lights, discharge lamps, or light emitting diodes (LEDs), are not perfect blackbody radiators whose radiation falls along the Planckian locus. For example, an LED or a neon sign emit light through electroluminescence, and the color of the light does not follow the Planckian locus. The color temperature determined for such light sources may be a correlated color temperature (CCT). The CCT is the estimated color temperature for light sources whose colors do not fall exactly on the Planckian locus. For example, the CCT of a light source is the blackbody color temperature that is closest to the radiation of the light source. CCT may also be denoted in K.

CCT may be an approximation of the true color temperature for the scene. For example, the CCT may be a simplified color metric of chromaticity coordinates in the CIE 1931 color space. Many devices may use AWB to estimate a CCT for color balancing.

The CCT may be a temperature rating from warm colors (such as yellows and reds below 3200 K) to cool colors (such as blue above 4000 K). The CCT (or other color temperature) may indicate the tinting that will appear in an image captured using such light sources. For example, a CCT of 2700 K may indicate a red tinting, and a CCT of 5000 K may indicate a blue tinting.

Different lighting sources or ambient lighting may illuminate a scene, and the color temperatures may be unknown to the device. As a result, the device may analyze data captured by the image sensor to estimate a color temperature for an image (e.g., a frame). For example, the color temperature may be an estimation of the overall CCT of the light sources for the scene in the image. The data captured by the image sensor used to estimate the color temperature for a frame (e.g., image) may be the captured image itself.

After device 300 determines a color temperature for the scene (such as during performance of AWB), device 300 may use the color temperature to determine a color balance for correcting any tinting in the image. For example, if the color temperature indicates that an image includes a red tinting, device 300 may decrease the red value or increase the blue value for each pixel of the image, e.g., in an RGB space. The color balance may be the color correction (such as the values to reduce the red values or increase the blue values).

Example inputs to AWB process 404 may include the Bayer grade or Bayer grid (BG) statistics of the received image data determined via stats screening process 412, an exposure index (e.g., the brightness of the scene of the received image data), and auxiliary information, which may include the contextual information of the scene based on the audio input (as will be discussed in further detail below), depth information, etc. It should be noted that AWB process 404 may be included within camera controller 312 of FIG. 3 as a separate AWB module.

AE process 406 (e.g., within a 3A engine 403, which may be run a 3A algorithm) may include instructions for configuring, calculating, and/or storing an exposure setting of camera 302 of FIG. 3. An exposure setting may include an amount of sensor gain to be applied, an amount of digital gain to be applied, shutter speed and/or exposure time, an aperture setting, and/or an ISO setting to use to capture subsequent images. AE process 406 may use the audio input and/or the contextual information of the scene based on the audio input to determine and/or apply exposure settings faster. It should be noted that AE process 406 may be included within camera controller 312 of FIG. 3 as a separate AE module.

AF process 408 (e.g., within a 3A engine 403, which may be run a 3A algorithm) may include instructions for configuring, calculating and/or storing an auto focus setting of camera 302 of FIG. 3. AF process 408 may determine the auto focus setting (e.g., an initial lens position, a final lens position, etc.) based on the audio input and/or the contextual information of the scene based on the audio input. It should be noted that AF process 408 may be included within camera controller 312 of FIG. 3 as a separate AF module.

Demosaic processing unit 414 may be configured to convert the processed Bayer image data into RGB values for each pixel of an image. As explained above, Bayer data may only include values for one color channel (R, G, or B) for each pixel of the image. Demosaic processing unit 414 may determine values for the other color channels of a pixel by interpolating from color channel values of nearby pixels. In some ISP pipelines 402, demosaic processing unit 414 may come before AWB, AE, and/or AF processes 404, 406, 408 or after AWB, AE, and/or AF processes 404, 406, 408.

Other processing unit 416 may apply additional processing to the image after AWB, AE, and/or AF processes 404, 406, 408 and/or demosaic processing unit 414. The additional processing may include color, tone, and/or spatial processing of the image.

As previously mentioned, cameras are typically implemented with RGB sensors for capturing images. These RGB sensors include RGB sensor arrays. RGBW technology adds an additional white (W) pixel to an RGB sensor array to form an RGBW sensor. The addition of the white pixel into the RGB sensor array may allow for the camera be able to capture high-definition images, especially for low light, dim, and dull surroundings.

Since RGBW sensors have this unique pixel arrangement including white pixels, RGBW sensors are much more light-sensitive, as compared to RGB sensors. The addition of the white pixels to the RGB arrays allows for the prevention of distortion of the original RGB primary colors in the images. The advantage of RGBW technology is based on the fact that with the inclusion of the white pixels, an improvement (e.g., 1.7 times better) in light sensitivity can be achieved. This improved light sensitivity can allow for better overall brightness of the camera images and reduced color distortions in the images.

However, RGBW sensors may produce noisy images in bright light scene scenarios because the exposing for the white pixel can underexpose the RGB pixels. During image processing of an image captured by an RGBW sensor, the RGBW pattern in a raw format can be converted into to an RGB domain, which can then be transformed into a YUV domain. In the YUV domain, the W component (signal) can be added to a Y channel of the RGB image to reach a higher luma. U channel and V channel of the YUV domain can be normalized by using the W component, such as by using a factor of (Y+W) Y, to adjust the luminance and maintain the color saturation.

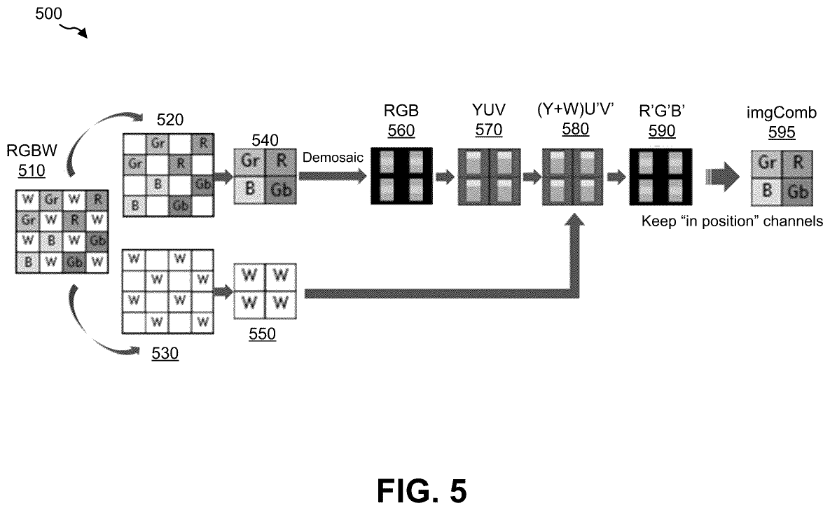

FIG. 5 shows an example of image processing for RGBW sensors. In particular, FIG. 5 is a block diagram showing an example 500 of RGBW image processing (e.g., image processing of an image frame captured by an RGBW sensor, such as image sensor 130 of FIG. 1). In FIG. 5, a raw format image frame (e.g., including a RGBW pattern 510) captured by a RGBW sensor is shown. The main advantage of a RGBW pattern (e.g., RGBW pattern 510) is that it has better luma noise, as opposed to RGB patterns, because the W component has a high level of sensitivity than any other color filter.

During the processing of the raw format image frame, from the raw format image frame (e.g., RGBW pattern 510), a W component (signal) can be separated out (e.g., as shown in W pattern 530) leaving a remaining RGBW pattern 520. The W pattern 530 can be converted to W pattern 550. The remaining RGBW pattern 520 can be converted to RGBW pattern 540. The RBGW pattern 540 can be processed by using a demosaic algorithm (e.g., run by demosaic processing unit 414 of FIG. 4) to be converted to rgb pattern 560. rgb pattern 560 can then be converted into a YUV domain, as shown in YUV pattern 570. The YUV pattern 570 can be enhanced by adding the W component (signal) to the Y channel (e.g., Y can be substituted with Y+W) to reach a higher luma. The YUV pattern 570 can also be enhanced by normalizing the U channel and the V channel by using the W component, by using a factor of (Y+W) Y, to adjust the luminance and maintain the color saturation. The enhanced YUV pattern is shown as (Y+W) U′V′ pattern 580. The (Y+W) U′V′ pattern 580 can be converted to an r′b′g′ pattern 590 (e.g., an enhanced rgb pattern). As such, the final output image 595 is a combination of an RGB image and a monochromatic image. The processing of the raw format image frame, as shown in FIG. 5, does not include any format for denoising, which is a basic requirement for many image quality tests.

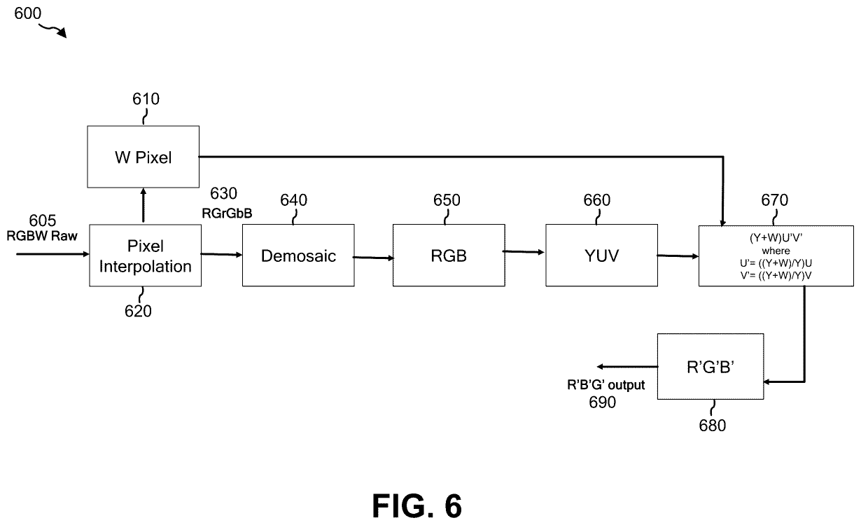

FIG. 6 shows an example of a process for RGBW image processing. In particular, FIG. 6 is flow chart showing an example of a process 600 for RGBW image processing (e.g., image processing of an image frame captured by an RGBW sensor, such as image sensor 130 of FIG. 1). In FIG. 5, a RGBW raw format image frame 605 is processed. During the process 600, pixel interpolation 620 can be performed on the RGBW raw format image frame 605 to produce a RGrGbB pattern 630. A W component (signal) 610 can be separated out. Demosaicing 640 can be performed on the RGrGbB pattern 630 to produce a RGB pattern 650. The RGB pattern 650 can be converted into a YUV domain, as shown in YUV pattern 660. The YUV pattern 660 can be enhanced 670 by adding the W component (signal) to the Y channel (e.g., Y can be substituted with Y+W) to reach a higher luma. The YUV pattern 660 can be further enhanced 670 by normalizing the U channel and the V channel by using the W component, by using a factor of (Y+W) Y, to adjust the luminance and maintain the color saturation. The enhanced YUV pattern is shown as (Y+W) U′V′ pattern 670, where U′=((Y+W)/Y) U and Y′=((Y+W)/Y) V. The (Y+W) U′V′ pattern 670 can be converted to an R′B′G′ pattern 680 (e.g., an enhanced RGB pattern). The R′B′G′ pattern can then be output 690.

During a bright light scene scenario, the W component will be dominant, which can negatively affect the overall color saturation in an image (e.g., the colors in the image erroneously appear over saturated). As such, dim RGB pixels can suffer from strong crosstalk (e.g., interference) from the bright W pixels. This interference can cause an oversaturation of the colors in an image. As such, a technique for improving RGBW image quality in bright light scenarios can be useful.

In one or more aspects, systems and techniques provide for an improvement RGBW image quality. The systems and techniques described herein enhance the color saturation of images obtained by RGBW sensors in bright light scenarios. In one or more examples, the system and techniques, using different sensor frame rate modes (e.g., 60 frames per second (fps) and 30 fps modes), can vary the exposure during the capturing of image frames. The systems and techniques can perform blending of RGB components (signals) of the image frames along with using a W component (signal) from a low exposure image frame to achieve a reduction in noise and an improvement in dynamic range.

In one or more examples, during a bright light scene scenario, one image frame (e.g., a first image frame) with normal exposure can be captured, and one image frame (e.g., a second image frame) with a low and/or reduced exposure (e.g., to prevent the W component from saturating) can be captured. The RGB components (signals) from the normal exposure image frame and the W component (signal) from low exposure image frame can help to control the color saturation in the image. Stronger RGB signals (components) with lower noise and better dynamic range can help to improve the color saturation in bright light scenarios. Saturation information from the W pixels from normal (or safe) exposure image frames may be used to determine an exposure value for the subsequent (e.g., (N+1)^{th}) low and/or reduced exposure image frame.

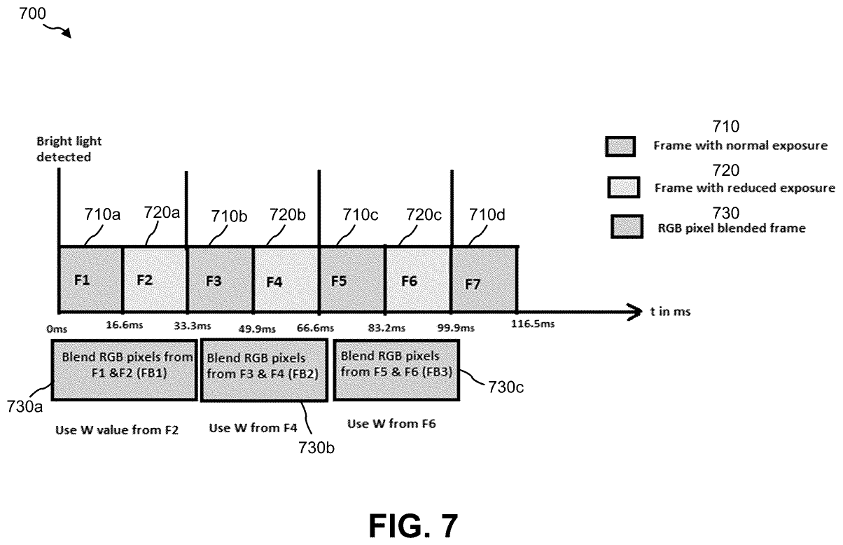

FIG. 7 shows an example of capturing and processing RGBW image frames. In particular, FIG. 7 is graph 700 showing an example of capturing and processing image frames using an RGBW sensor (e.g., image sensor 130 of FIG. 1) over time. In FIG. 7, for the graph 700, the x-axis represents time, and the y-axis represents an amount of bright light detected.

In one or more examples, during the capturing and processing of image frames of a scene using an RGBW sensor, the camera application (e.g., software) of the camera can be running at a sensor frame rate. In one or more examples, the sensor frame rate may be 30 frames per second (fps). In some examples, other sensor frame rates (e.g., 60 fps and 120 fps) may be used other than the 30 fps.

One or more processors (e.g., image processor 150 of FIG. 1, image signal processor 314 of FIG. 3, processor 306 of FIG. 3, and processor 1610 of FIG. 16) can determine whether the scene has a bright light scenario. The one or more processors can determine whether the scene has a bright light scenario by using (based on) a brightness threshold (e.g., a predetermined threshold related to brightness). The one or more processors can compare one or more parameters to the brightness threshold to determine whether a bright light scenario is present in the scene. In one or more examples, the one or more parameters may be associated with AF, AWB, and/or AE. The one or more processors may calculate these one or more parameters as they relate to the scene. In some examples, the one or more parameters can include a lux index.

If the one or more processors determines that the scene has a bright light scenario, the one or more processors can adjust the sensor frame rate. In one or more examples, the one or more processors can adjust the sensor frame rate by increasing the sensor frame rate. In some examples, the one or more processors can increase the sensor frame rate from 30 fps to 60 fps. In some examples, other sensor frame rates (e.g., 120 fps) may be used other than the 30 fps or the 60 fps.

In one or more examples, after the sensor frame rate has been adjusted, one or more RGBW sensors (e.g., image sensor 130 of FIG. 1) can capture one or more first image frames 710 with a first exposure. The first exposure may be a normal exposure (e.g., a safe exposure) that would normally be used for the detected bright light scenario. In the example of FIG. 7, the first image frames 710 are shown to include image frame F1 710a, image frame F3 710b, image frame F5 710c, and image frame F7 710d.

The one or more RGBW sensors (e.g., image sensor 130 of FIG. 1) can capture one or more second image frames 720 with a second exposure. The second exposure can be a lower and/or reduced exposure as compared to the first exposure. The one or more processors may determine the second exposure by using one or more parameters that are associated with AF, AWB, and/or AE. The one or more processors may calculate these one or more parameters as they relate to the scene. In one or more examples, the second exposure may be tunable based on the one or more parameters, such as lux index. The second exposure, which is lower than the first exposure, can prevent the W component from saturating in the bright light scenario. In the example of FIG. 7, the second image frames 720 are shown to include image frame F2 720a, image frame F4 720b, and image frame F6 720c.

As shown in the graph 700 of FIG. 7, the first image frames 710 and the second image frames 720 can be captured alternatively over time (e.g., alternating over time) so that a first image frame of the first image frames 710 is captured, followed by a first image frame of the second image frames 720, followed by a second image frame of the first image frames 710, followed by a second image frame of the second image frames 720, and so on. In the graph 700, the each of the first image frames 710 and the second image frames 720 is shown to be captured over a 16.6 milliseconds duration (e.g., using a 60 fps sensor frame rate). In one or more examples, the first image frames 710 and the second image frames 720 can be captured in different patterns than in the alternating pattern as is shown in the graph 700 of FIG. 7.

In one or more examples, the one or more processors can blend RGB components (signals) of the first image frames with RGB components (signals) of adjacent second image frames to produce blended image frames. For example, as shown in the graph 700 of FIG. 7, the RGB components of first image frame F1 710a can be blended with the RGB components of the second image frame F2 720a (which is adjacent to the first image frame F1 710a) to produce blended image frame FB1 730a, the RGB components of first image frame F3 710b can be blended with the RGB components of the second image frame F2 720b to produce blended image frame FB2 730b, and the RGB components of first image frame F5 710c can be blended with the RGB components of the second image frame F6 720c to produce blended image frame FB3 730c.

In one or more examples, the one or more processors can apply a W component (signal) of the second image frames to the blended frames. For example, as shown in the graph 700 of FIG. 7, the W component of second image frame F2 720a can be applied to the blended image frame FB1 730a, the W component of second image frame F4 720b can be applied to the blended image frame FB2 730b, and the W component of second image frame F6 720c can be applied to the blended image frame FB3 730c. The applying of the W component from the second image frames to the blended frames can help to achieve a better controlled color saturation, which can help to improve the image quality in bright light scenarios.

In one or more examples, the N^{th} frame (e.g., referred to as “FN”) may be captured with the first exposure (e.g., which may be a normal eposure), and the (N+1)^{th} frame (e.g., referred to as “FN+1”) may be captured with the second exposure (e.g., which may be a lower and/or reduced exposure, than the first exposure) during a bright light scene scenerio. For any N^{th} frame, the blended frame (e.g., which may be referred to as “FB”) may be:

FB=Blend(RGB(N),RGB(N+1)),which can provide a better dynamic range

W can be used from the N+1 frame to get the following:

$${Y}^{′} = FB ( Y ) + FN + 1 ( W )$$

$${U}^{′} = FB ( U ) * ( FB ( Y ) + FN + 1 ( W ) ) / FB ( Y )$$

$${V}^{′} = FB ( V ) * ( FB ( Y ) + FN + 1 ( W ) ) / FB ( Y )$$

The first portion of each of the above formulas can increase the dynamic range, and the second portion of each of the above formulas can help to control the W signal. Both of these advantages can result in better color saturation in an image taken of a scene in a bright light scenario.

In some examples, the N^{th} frame (FN) may be captured with the first exposure (e.g., which may be a lower and/or reduced exposure, than the second exposure), and (N+1)^{th} frame (FN+1) may be captured with a second exposure (e.g., which may be a normal exposure) during a bright light scene scenerio.

For any N^{th} frame, the Blended frame (FB) may be:

FB=Blend(RGB(N),RGB(N+1)),which can provide a better dynamic range

W can be used from the N frame to get the following:

$${Y}^{′} = FB ( Y ) + FN ( W )$$

$${U}^{′} = FB ( U ) * ( FB ( Y ) + FN ( W ) ) / FB ( Y )$$

$${V}^{′} = FB ( V ) * ( FB ( Y ) + FN ( W ) ) / FB ( Y )$$

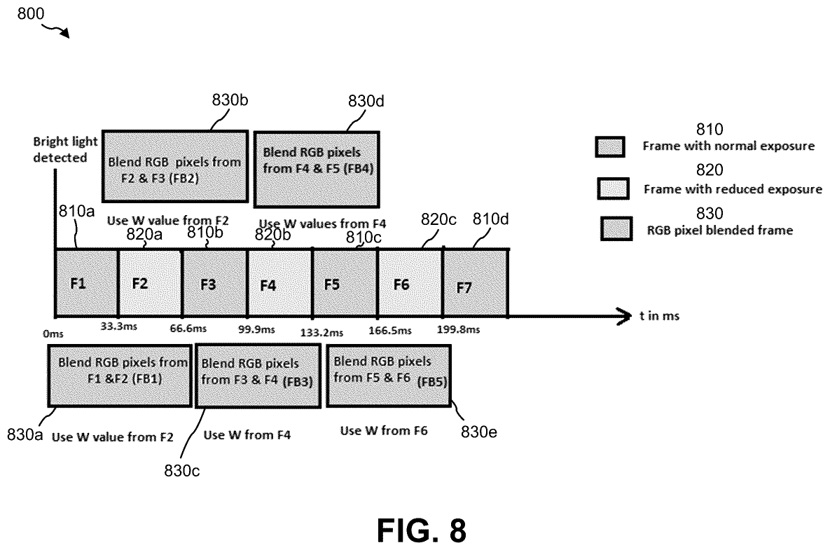

FIG. 8 show another example of capturing and processing RGBW image frames. In particular, FIG. 8 is graph 800 showing another example of capturing and processing image frames using an RGBW sensor (e.g., image sensor 130 of FIG. 1) over time. In FIG. 8, for the graph 800, the x-axis represents time, and the y-axis represents an amount of bright light detected.

In one or more examples, during the capturing and processing of image frames of a scene using an RGBW sensor, the camera application (e.g., software) of the camera may be running at a sensor frame rate. In one or more examples, the sensor frame rate can be 30 frames per second (fps). Other sensor frame rates (e.g., 60 fps and 120 fps) may be used other than the 30 fps used in FIG. 8.

One or more processors (e.g., image processor 150 of FIG. 1, image signal processor 314 of FIG. 3, processor 306 of FIG. 3, and processor 1610 of FIG. 16) may determine whether the scene has a bright light scenario. The one or more processors may determine whether the scene has a bright light scenario by using (based on) a brightness threshold (e.g., a predetermined threshold related to brightness). The one or more processors may compare one or more parameters to the brightness threshold to determine whether a bright light scenario is present in the scene. The one or more parameters may be associated with AF, AWB, and/or AE. The one or more processors can calculate these one or more parameters as they relate to the scene. The one or more parameters may include a lux index.

One or more RGBW sensors (e.g., image sensor 130 of FIG. 1) may capture one or more first image frames 810 with a first exposure, which may be a normal exposure (e.g., a safe exposure) that would normally be used for the detected bright light scenario. In the example of FIG. 8, the first image frames 810 are shown to include image frame F1 810a, image frame F3 810b, image frame F5 810c, and image frame F7 810d.

The one or more RGBW sensors (e.g., image sensor 130 of FIG. 1) can capture one or more second image frames 820 with a second exposure, which can be a lower and/or reduced exposure as compared to the first exposure. The one or more processors can determine the second exposure by using one or more parameters that are associated with AF, AWB, and/or AE. The one or more processors may calculate these one or more parameters as they relate to the scene. In some examples, the second exposure may be tunable based on the one or more parameters, such as the lux index. The second exposure, which is lower than the first exposure, can prevent the W component from saturating in the bright light scenario. In the example of FIG. 8, the second image frames 820 are shown to include image frame F2 820a, image frame F4 820b, and image frame F6 820c.

In the graph 800, the first image frames 810 and the second image frames 820 can be captured alternatively over time (e.g., alternating over time). In the graph 800, the each of the first image frames 810 and the second image frames 820 is shown to be captured over a 33.3 milliseconds duration (e.g., using a 30 fps sensor frame rate). In some examples, the first image frames 710 and the second image frames 820 may be captured in different patterns than in the alternating pattern as is shown in the graph 800 of FIG. 8.

The one or more processors can blend RGB components (signals) of the first image frames with RGB components (signals) of adjacent second image frames to produce blended image frames. For example, as shown in the graph 800 of FIG. 8, the RGB components of first image frame F1 810a can be blended with the RGB components of the second image frame F2 820a to produce blended image frame FB1 830a, the RGB components of first image frame F3 810b can be blended with the RGB components of the second image frame F2 820b to produce blended image frame FB2 830c, and the RGB components of first image frame F5 810c can be blended with the RGB components of the second image frame F6 820c to produce blended image frame FB3 830e.

In one or more examples, the one or more processors can blend RGB components (signals) of the second image frames with RGB components (signals) of adjacent first image frames to produce blended image frames. For example, as shown in the graph 800 of FIG. 8, the RGB components of second image frame F2 820a can be blended with the RGB components of the first image frame F3 810b to produce blended image frame FB2 830b, and the RGB components of second image frame F4 820b can be blended with the RGB components of the first image frame F5 810c to produce blended image frame FB4 830d.

In one or more examples, the one or more processors can apply a W component (signal) of the second image frames to the blended frames. For example, as shown in the graph 800 of FIG. 8, the W component of second image frame F2 820a can be applied to the blended image frame FB1 830a, the W component of second image frame F4 820b can be applied to the blended image frame FB3 830c, and the W component of second image frame F6 820c can be applied to the blended image frame FB5 830e, the W component of second image frame F2 820a can be applied to the blended image frame FB2 830b, and the W component of second image frame F4 820b can be applied to the blended image frame FB4 830d. Applying the W component from the second image frames to the blended frames can allow for a better controlled color saturation, which can improve the image quality in bright light scenarios.

In one or more examples, all odd numbers of image frames may be captured, by the one or more RGBW sensors, over time with a first exposure, which may be a normal exposure (e.g., a desired or safe exposure). All even numbers of the image frames may be captured, by the one or more RGBW sensors, over time with a second exposure, which may be a lower or reduced exposure as compared to the first exposure.

In one or more examples, it can be assumed that all odd numbers of images frames are captured with a first exposure (e.g., a normal or safe exposure), and all even numbers of image frames are captured with a second exposure (e.g., a lower or reduced exposure as compared to the first exposure) to prevent W from saturation. For example, image frames F1, F3, F5, F7, . . . , etc. are captured with the first exposure, and image frames F2, F4, F6, F8, . . . , etc. are captured with the second exposure. As such, the output frame order for the camera application can be:

Fout1=Blend(F1,F2), then apply W component from F2 to enhance brightness.

Fout2=Blend(F2,F3), then apply W component from F2 to enhance brightness

Fout3=Blend(F3,F4), then apply W component from F4 to enhance brightness

Fout4=Blend(F4,F5), then apply W component from F4 to enhance brightness

In one or more examples, in scenes with a high dynamic range (HDR), since the W pixel is more sensitive, using the W component for normalization may make colors very saturated. For example, the W pixel can be 38 percent (%) more sensitive than Y under D65.

In one or more examples, Y, U and V may be normalized by using normalization factors (e.g., a, b, and c), as shown:

$${Y}^{′} = aY + bW$$

$${U}^{′} = ( ( aY + bW ) / cY ) U$$

$${V}^{′} = ( ( aY + bW ) / cY ) V ,$$

where a, b, and c can be calculated based on the lux index, CCT triggers, and/or other tuning trigger parameters. The use of these normalization factors can provide better image quality results overall, especially for HDR Scenes since frames with different exposures (e.g., long, safe, and short exposures) should be normalized with different factors to avoid saturation of the pixels since W sensitivity is different under different lighting conditions. These normalization factors can be tuned for low light conditions to avoid crosstalk in dim RGB pixels from bright W pixels. In one or more examples, the a, b and c coefficients can be tuned for different lux, CCT, and/or gain triggers during image quality tuning (e.g., during manufacturing) for a particular RBGW sensor.

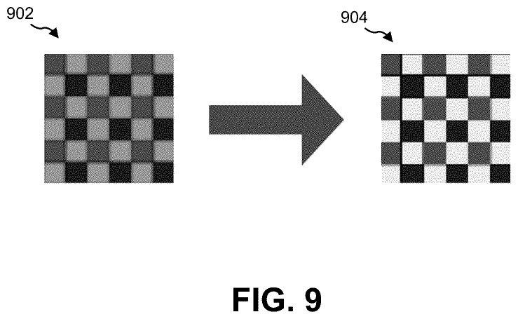

As noted previously, systems and techniques are also described herein for improving red yellow blue (RYYB) image quality. FIG. 9 is a diagram illustrating an example of an RGB pattern 902 for capturing an RGB frame and an example of an RYYB pattern 904 for capturing an RYYB frame. As indicated by the RGB pattern 902, a common arrangement is for each 2×2 group of pixels to have filters arranged in a pattern with one red (R) component, two green (G) components, and one blue (B) component. Such a pattern is commonly referred to as an RGGB filter, reflecting the fact that there are two green-filter pixels for each red and blue filter pixel.

As shown by the RYYB pattern 904, an RYYB sensor can use the same pattern as an RGGB filter, but with the green filter replaced by a yellow filter. Using yellow instead of green can make the two Y pixels more sensitive to light, which can result in good image quality. For example, replacing the standard RGB green channel with yellow may result in more color dynamics, potentially capturing 40 percent more light across green and red channels, with algorithms separating the colors for image processing.

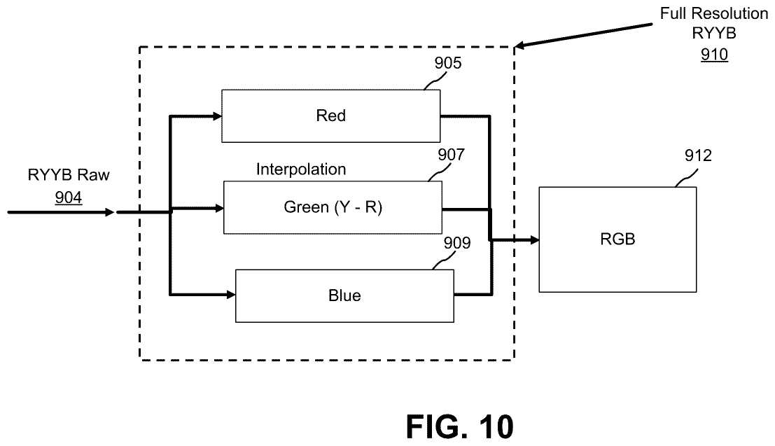

However, the green intensity at the Y pixels will have to be calculated by subtracting an estimate of red intensity (e.g., interpolated from adjacent red pixels) from the yellow pixels, which may increase noise and reduce sharpness in the green color. FIG. 10 is a diagram illustrating an example of generating an RGB frame 912 based on a full-resolution RYYB frame 910. For instance, raw RYYB frame data 904 is processed to obtain a red component 905 (or channel) from the raw RYYB frame data 904 and a blue component 909 (or channel) from the raw RYYB frame data 904. A green component 907 (or channel) can be interpolated based on the Y component and R component of the raw RYYB frame data 904. For instance, as shown in FIG. 10, the green component 907 can be calculated by subtracting an estimate of red intensity (e.g., interpolated from adjacent red pixels) from the yellow pixels.

In some cases, the Y channel or intensity can be calculated as follows:

$$Y = R + G + delta ( R )$$

where delta (R) is R channel crosstalk.

The yellow channel inherently has more cross talk with the red channel due to spectrum overlapping with red, leading to difficulty in reproducing green colors. RYYB also has higher red crosstalk with the blue channel. For instance, for an RYYB sensor when capturing frames in scenes with bright lighting, the yellow pixels may have more cross talk. When capturing frames in low-light scenes, the blue pixels may have more cross talk. Also, for an RYYB sensor, dark patches may have higher luma noise even with higher SNR. White balance applied to RYYB frames may also boost blue and/or red channel noise, such as for blue under low light conditions.

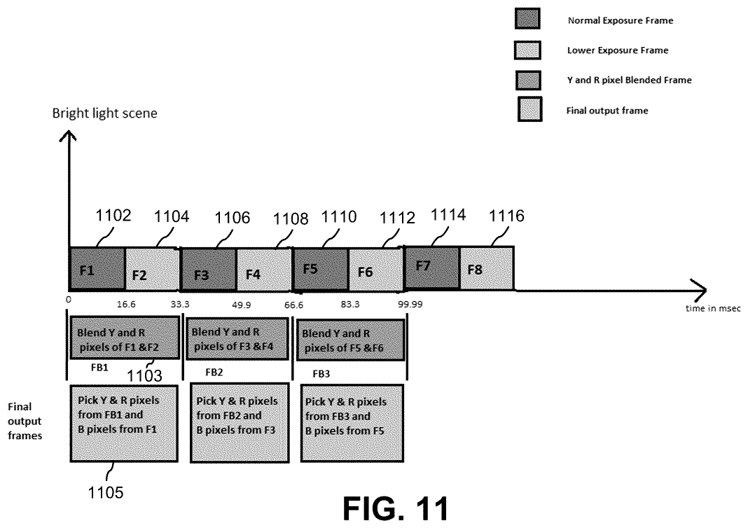

FIG. 11 is a diagram illustrating an example of enhancing RYYB frames in bright light scenarios (when capturing frames in scenes with bright light). For example, one or more processors (e.g., image processor 150 of FIG. 1, image signal processor 314 of FIG. 3, processor 306 of FIG. 3, and processor 1610 of FIG. 16) can increase a frame rate from a normal-operating frame rate to an increased frame rate, such as from a normal-operating frame rate of 30 fps an increased frame rate of 60 fps. While operating at the increased frame rate (e.g., 60 fps), the one or more processors can cause an image capture device (e.g., image processing system 100 of FIG. 1) to capture a first frame 1102 at a first exposure and a second frame 1104 with a second exposure that is reduced with respect to the first exposure. The first frame 1102 and the second frame 1104 are RYYB frames.

The one or more processors can take blue pixels from the first frame 1102 (e.g., the blue component 909 shown in FIG. 10), and can blend Y and R pixels (e.g., as shown in FIG. 10) from both the first frame 1102 and the second frame 1104 to generate a blended frame 1103 (denoted in FIG. 11 as blended frame FB1). To generate a final output frame 1105, the one or more processors can select Y and R pixels from the blended frame 1103 and can use blue pixels from the first frame 1102. A similar operation can be performed for additional frames 1106, 1108, 1110, 1112, 1114, and 1116 in FIG. 11 (resulting in blended frames FB2 and FB3). In some cases, the one or more processors can blend R pixels, which may provide a better dynamic range for the output frames.

In one illustrative example, assuming an Nth frame (FN) captured with normal eposure and an (N+1)th frame (FN+1) captured with lower/reduced exposure during bright light scenerios, the following can be performed:

For any Nth frame Blended frame FB:
FB( Y,R )= Blend ( FN ( Y, R ) FN+1( Y, R ) ) → Helps to Reduce delta(R) factor
Use B from FN frame

| | |
|---|---|
| R = | FB (R) |
| G = | FB ( Y ) − FB ( R) − delta( R ) → Reduced delta(R) and improves SNR for G |
| B = | FN( B ) |

Such a solution can result in an improved G signal, including better color saturation with improved SNR as delta (R) or crosstalk is reduced for Y and R pixels.

In another illustrative example, assuming an Nth frame (FN) captured with lower/reduced eposure and an (N+1)th frame (FN+1) captured with normal exposure during bright light scenerios, the following can be performed:

For any Nth frame Blended frame FB:
FB( Y,R )= Blend ( FN ( Y, R ) FN+1( Y, R ) ) → Helps to Reduce delta(R) factor
Use B from FN+1 frame

| | |
|---|---|
| R = | FB (R) |
| G = | FB( Y )− FB ( R ) − delta( R ) → Reduced delta(R) and improves SNR for G |
| B = | FN+1( B ) |

Such a solution can result in an improved G signal, with better color saturation.

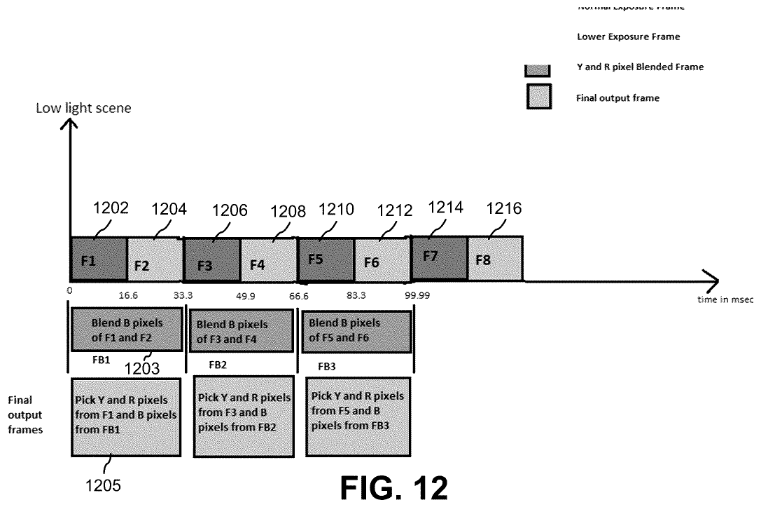

FIG. 12 is a diagram illustrating an example of enhancing RYYB frames in low light scenarios (when capturing frames in scenes with low light). For example, one or more processors (e.g., image processor 150 of FIG. 1, image signal processor 314 of FIG. 3, processor 306 of FIG. 3, and processor 1610 of FIG. 16) can increase a frame rate from a normal-operating frame rate to an increased frame rate, such as from a normal-operating frame rate of 30 fps an increased frame rate of 60 fps. While operating at the increased frame rate (e.g., 60 fps), the one or more processors can cause an image capture device (e.g., image processing system 100 of FIG. 1) to capture a first frame 1202 at a first exposure and a second frame 1204 with a second exposure that is reduced with respect to the first exposure. The first frame 1202 and the second frame 1204 are RYYB frames.

The one or more processors can take Y and R pixels from the first frame 1202 and can blend B pixels from both the first frame 1202 and the second frame 1202 to generate a blended frame 1203 (denoted in FIG. 12 as blended frame FB1). To generate a final output frame 1205, the one or more processors can select Y and R pixels from the first frame 1202 and can use blue pixels from the blended frame 1203. A similar operation can be performed for additional frames 1206, 1208, 1210, 1212, 1214, and 1216 in FIG. 12 (resulting in blended frames FB2 and FB3). In some cases, the systems and techniques can blend R and Y pixels for better dynamic range.

In one illustrative example, assuming an Nth frame (FN) captured with normal eposure and an (N+1)th frame (FN+1) captured with lower/reduced exposure during bright light scenerio, the following can be performed:

For any Nth frame Blended frame FB:
FB( B )= Blend ( FN ( B) FN+1( B) ) → Helps to improve B Signal
Use R and Y from FN frame

| | |
|---|---|
| R = | FN (R) |
| G = | FN( Y ) − FN ( R ) − delta( R ) |
| B = | FB( B ) |

Such a solution can result in an improved B signal, with better color saturation an improved SNR as delta (R) or crosstalk is reduced for B pixels.

In another illustrative example, assuming an Nth frame (FN) captured with lower/reduced eposure and an (N+1)th frame (FN+1) captured with normal exposure during bright light scenerio, the following can be performed:

For any Nth frame Blended frame FB:
FB( B )= Blend ( FN ( B) FN+1( B) ) → Helps to improve B Signal
Use R and Y from FN frame

| | |
|---|---|
| R = | FN+1 (R) |
| G = | FN+1( Y ) − FN+1 ( R ) − delta( R ) |
| B = | FB( B ) |

(

Such a solution can result in an improved B signal with better color saturation.

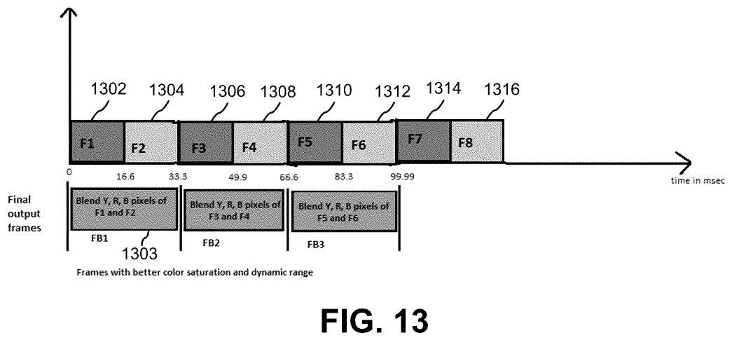

FIG. 13 is a diagram illustrating an example of varying Sensor Analog Gain (ISO gain) for frames. For example, various RYYB frames 1302, 1304, 1306, 1308, 1310, 1312, 1314, and 1316 can be captured at a particular frame rate (e.g., 60 fps). One or more processors (e.g., image processor 150 of FIG. 1, image signal processor 314 of FIG. 3, processor 306 of FIG. 3, and processor 1610 of FIG. 16) can cause an image capture device (e.g., image processing system 100 of FIG. 1) to capture a first frame 1302 at a normal analog gain (e.g., calculated using a 3A algorithm as described herein) and can capture a second frame 1304 with lower analog gain.

The one or more processors can blend the first frame 1302 and the second frame 1304 to generate a blended frame 1303 (denoted in FIG. 13 as blended frame FB1). For example, as shown in FIG. 13, the one or more processors can blend the Y, R, and B pixels of the first frame 1302 and the second frame 1304 to generate the blended frame 1303. The blended frame 1303 can be used as an output frame. A similar operation can be performed for additional frames 1306, 1308, 1310, 1312, 1314, and 1316 in FIG. 13 (resulting in blended frames FB2 and FB3).

Such a solution can help to reduce the delta (R) component and can provided a boosted signal for the B components. By reducing the delta (R) component and boosting the B pixel, better color saturation can be achieved. Further, blending frames with two different analog gains can help to achieve better dynamic range and improved SNR.

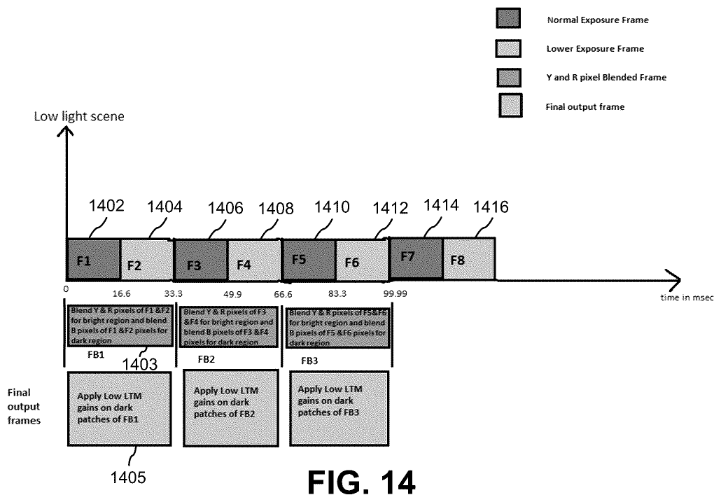

In some cases, dark regions or patches in frames have higher luma noise even with higher SNR. FIG. 14 is a diagram illustrating an example of processing frames in a low-light scene. In some aspects, one or more processors (e.g., image processor 150 of FIG. 1, image signal processor 314 of FIG. 3, processor 306 of FIG. 3, and processor 1610 of FIG. 16) can cause an image capture device (e.g., image processing system 100 of FIG. 1) to capture RYYB frames 1402, 1404, 1406, 1408, 1410, 1412, 1414, and 1416 at a particular frame rate (e.g., 30 fps, 60 fps, etc.).

For bright regions in the frames, the one or more processors can blend Y and R pixels of a first frame 1402 and a second frame 1404. For dark regions in the frames, the one or more processors can blend B pixels of the first frame 1402 and the second frame 1404. In some cases, an ISP (as an example of the one or more processors) can apply lower local tone mapping (LTM) gain on dark regions (e.g., patches) of the blended frame 1403 to generate a final output frame 1405. The blended pixels can be included in a blended frame 1403 (denoted in FIG. 14 as a blended frame FB1). Similar operations can be performed on the frames 1406, 1408, 1410, 1412, 1414, and 1416 in FIG. 14 (resulting in blended frames FB2 and FB3 and corresponding output frames).

Applying lower LTM gains in dark patches can help suppress amplification of luma noise. Blending of B pixels in dark regions/patches can help to reduce the luma noise. Such a solution can correct for color reproduction issues (e.g., greyish-green colors). Such a solution can also correct for red dark areas.

In some cases, both channels of RYYB frames may have higher gain than a Bayer pattern (e.g., the RGB pattern 902 in FIG. 9). The red gain difference between frames captured using RYYB and Bayer patterns has almost no change with light intensity (e.g., low-light versus bright-light scenarios). For instance, the average gain difference is 0.58. The blue gain difference of frames captured using RYYB and Bayer patterns increases quickly as light intensity decreases (e.g., from a bright-light scenario to a low-light scenario). White balance of frames captured using a RYYB pattern can boost blue and red channels, such as for blue under low-light conditions.

A QE curve shows that yellow is approximately the sum of green and red channels. Because the red gain difference between frames captured using RYYB and Bayer patterns is approximately constant (e.g., a gain difference of 0.58), it can be assumed that blue and red components are the same for both RYYB and Bayer sensors.

Systems and techniques are described herein that provide tunable gain during low-light scenarios. For instance, a particular gain (e.g., the 0.58 gain noted previously) can be tunable based on light condition. In one example, for low-light scenarios, constant should be less and tunable for lower lux regions. For such low-light scenarios, gain can be less than 0.58, which can help to improve gyb gain. Such a solution can help to improve White balance in low light.

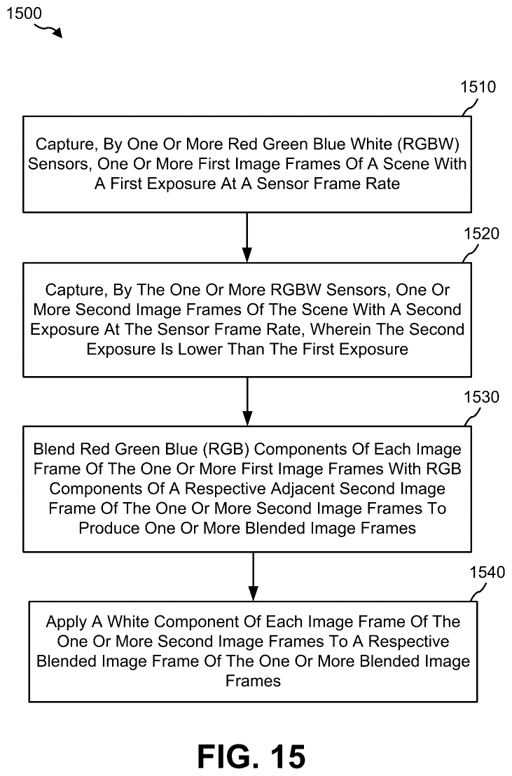

FIG. 15 is a flow chart illustrating an example of a process 1500 for image processing. The process 1500 can be performed by a computing device including one or more cameras or image sensors (e.g., camera 302 and/or device 300 of FIG. 3) or by a component or system (e.g., a chipset, at least one processor such as an ISP or other processor, or other component or system) of the computing device. In one or more examples, the camera(s) or image sensor(s) may include one or more red green blue white (RGBW) sensors. The camera(s) or image sensor(s) be implemented within (e.g., housed within), communicatively connected to, and/or associated with the computing device. The operations of the process 900 may be implemented as software components that are executed and run on one or more processors (e.g., image processor 150 of FIG. 1, processor 306 of FIG. 3, image signal processor 314 of FIG. 3, and/or processor 1610 of FIG. 16, or other processor(s)), which may be implemented within the camera and/or the device.

At block 1510, the computing device can capture, using one or more RGBW sensors (or a processor or other component can cause the one or more RGBW sensors to capture), one or more first image frames of a scene with a first exposure at a sensor frame rate. In some aspects, the one or more first image frames and the one or more second image frames are alternatively captured (e.g., the image frame 710a of and the image frame 720a of FIG. 7, which are illustrated in FIG. 7 as being alternatively captured). In some cases, the one or more first image frames are an odd number of image frames captured by the one or more RGBW sensors, and the one or more second image frames are an even number of the image frames captured by the one or more RGBW sensors, such as shown in FIG. 7 (e.g., with image frames 710a, 710b, 710c, and 710d being odd image frames and image frames 720a, 720b, and 720c being even image frames) and FIG. 8 (e.g., with image frames 810a, 810b, 810c, and 810d being odd image frames and image frames 820a, 820b, and 820c being even image frames).

In some aspects, the computing device (or component thereof) can detect a bright light scenario for the scene based on at least one image frame of the scene exceeding a brightness threshold. In some cases, the computing device (or component thereof) can adjust the sensor frame rate based on detecting the bright light scenario for the scene. In some examples, the brightness threshold is based on one or more parameters. In some cases, the one or more parameters may be associated with one or more 3A settings, such as automatic focus (AF), automatic white balance (AWB), and/or automatic exposure (AE). Additionally or alternatively, in some cases, the one or more parameters comprise a lux index.

At block 1520, the computing device (or component thereof) can capture, by the one or more RGBW sensors (or a processor or other component can cause the one or more RGBW sensors to capture), one or more second image frames of the scene with a second exposure at the sensor frame rate. The second exposure is lower than the first exposure. In some cases, the computing device (or component thereof) can determine the second exposure based on one or more parameters associated with one or more 3A settings, such as AF, AWB, and/or AE.

At block 1530, the computing device (or component thereof) can blend red green blue (RGB) components of each image frame of the one or more first image frames with RGB components of a respective adjacent second image frame of the one or more second image frames to produce one or more blended image frames. In some aspects, the computing device (or component thereof) can blend the RGB components of each frame of the one or more second image frames with RGB components of a respective adjacent first image frame of the one or more first image frames, such as shown in FIG. 7 (e.g., blending RGB pixels from image frame 720a and adjacent image frame 710a) and FIG. 8 (e.g., blending RGB pixels from image frame 820a and adjacent image frame 810a).

At block 1540, the computing device (or component thereof) can apply a white component of each image frame of the one or more second image frames to a respective blended image frame of the one or more blended image frames.

The camera (e.g., camera 302 of FIG. 3) and/or the computing device (e.g., device 300 of FIG. 3) may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the camera and/or device configured to perform the process 1500 of FIG. 15 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1500 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1500 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 16 is a block diagram illustrating an example of a computing system 1600, which may be employed by the disclosed systems and techniques for improving RGBW image quality. In particular, FIG. 16 illustrates an example of computing system 1600, which can be, for example, any computing device making up internal computing system, a remote computing system, a camera, or any component thereof in which the components of the system are in communication with each other using connection 1605. Connection 1605 can be a physical connection using a bus, or a direct connection into processor 1610, such as in a chipset architecture. Connection 1605 can also be a virtual connection, networked connection, or logical connection.

In some aspects, computing system 1600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1600 includes at least one processing unit (CPU or processor) 1610 and connection 1605 that communicatively couples various system components including system memory 1615, such as read-only memory (ROM) 1620 and random access memory (RAM) 1625 to processor 1610. Computing system 1600 can include a cache 1612 of high-speed memory connected directly with, in close proximity to, or integrated as part of processor 1610.

Processor 1610 can include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms. In some instances, multimodal systems can enable a user to provide multiple types of input/output to communicate with computing system 1600.

Computing system 1600 can include communications interface 1640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1640 may also include one or more range sensors (e.g., light-based sensors, laser range finders, RF-based sensors, ultrasonic sensors, and infrared (IR) sensors) configured to collect data and provide measurements to processor 1610, whereby processor 1610 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1630 can include software services, servers, services, etc., that when the code that defines such software is executed by the processor 1610, it causes the system to perform a function. In some aspects, a hardware service that performs a particular function can include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for processing one or more images, the apparatus comprising: at least one memory; and at least one processor coupled to the at least one memory and configured to: obtain one or more first image frames of a scene captured by one or more red green blue white (RGBW) sensors with a first exposure at a sensor frame rate; obtain one or more second image frames of the scene captured by the one or more RGBW sensors with a second exposure at the sensor frame rate, wherein the second exposure is lower than the first exposure; blend red green blue (RGB) components of each image frame of the one or more first image frames with RGB components of a respective adjacent second image frame of the one or more second image frames to produce one or more blended image frames; and apply a white component of each image frame of the one or more second image frames to a respective blended image frame of the one or more blended image frames.
Aspect 2. The apparatus of Aspect 1, wherein the one or more first image frames and the one or more second image frames are alternatively captured.
Aspect 3. The apparatus of Aspect 2, wherein the one or more first image frames are an odd number of image frames captured by the one or more RGBW sensors, and the one or more second image frames are an even number of the image frames captured by the one or more RGBW sensors.
Aspect 4. The apparatus of any one of Aspects 1 to 3, wherein the at least one processor is configured to detect a bright light scenario for the scene based on at least one image frame of the scene exceeding a brightness threshold.
Aspect 5. The apparatus of Aspect 4, wherein the brightness threshold is based on one or more parameters.
Aspect 6. The apparatus of Aspect 5, wherein the one or more parameters are associated with at least one of automatic focus (AF), automatic white balance (AWB), or automatic exposure (AE).
Aspect 7. The apparatus of any one of Aspects 5 or 6, wherein the one or more parameters comprise a lux index.
Aspect 8. The apparatus of any one of Aspects 4 to 7, wherein the at least one processor is configured to adjust the sensor frame rate based on detecting the bright light scenario for the scene.
Aspect 9. The apparatus of any one of Aspects 1 to 8, wherein the at least one processor is configured to blend the RGB components of each frame of the one or more second image frames with RGB components of a respective adjacent first image frame of the one or more first image frames.
Aspect 10. The apparatus of any one of Aspects 1 to 9, wherein the at least one processor is configured to determine the second exposure based on one or more parameters associated with at least one of automatic focus (AF), automatic white balance (AWB), or automatic exposure (AE).
Aspect 11. The apparatus of any one of Aspects 1 to 10, wherein the at least one processor includes an image signal processor (ISP).
Aspect 12. A method for image processing, the method comprising: capturing, by one or more red green blue white (RGBW) sensors, one or more first image frames of a scene with a first exposure at a sensor frame rate; capturing, by the one or more RGBW sensors, one or more second image frames of the scene with a second exposure at the sensor frame rate, wherein the second exposure is lower than the first exposure; blending red green blue (RGB) components of each image frame of the one or more first image frames with RGB components of a respective adjacent second image frame of the one or more second image frames to produce one or more blended image frames; and applying a white component of each image frame of the one or more second image frames to a respective blended image frame of the one or more blended image frames.
Aspect 13. The method of Aspect 12, wherein the one or more first image frames and the one or more second image frames are alternatively captured.
Aspect 14. The method of Aspect 13, wherein the one or more first image frames are an odd number of image frames captured by the one or more RGBW sensors, and the one or more second image frames are an even number of the image frames captured by the one or more RGBW sensors.
Aspect 15. The method of any one of Aspects 12 to 14, further comprising detecting a bright light scenario for the scene based on at least one image frame of the scene exceeding a brightness threshold.
Aspect 16. The method of Aspect 15, wherein the brightness threshold is based on one or more parameters.
Aspect 17. The method of Aspect 16, wherein the one or more parameters are associated with at least one of automatic focus (AF), automatic white balance (AWB), or automatic exposure (AE).
Aspect 18. The method of any one of Aspects 16 or 17, wherein the one or more parameters comprise a lux index.
Aspect 19. The method of any one of Aspects 15 to 18, further comprising adjusting the sensor frame rate based on detecting the bright light scenario for the scene.
Aspect 20. The method of any one of Aspects 12 to 19, further comprising blending the RGB components of each frame of the one or more second image frames with RGB components of a respective adjacent first image frame of the one or more first image frames.
Aspect 21. The method of any one of Aspects 12 to 20, further comprising determining the second exposure based on one or more parameters associated with at least one of automatic focus (AF), automatic white balance (AWB), or automatic exposure (AE).
Aspect 22. A non-transitory computer-readable storage medium comprising instructions stored thereon which, when executed by at least one processor, causes the at least one processor to perform operations according to any of Aspects 12 to 21.
Aspect 23. An apparatus for processing one or more images, the apparatus including one or more means for performing operations according to any of Aspects 12 to 21.
Aspect 24. An apparatus for processing one or more images, the apparatus comprising: at least one memory; and at least one processor coupled to the at least one memory and configured to: obtain one or more first image frames of a scene captured by one or more red yellow blue (RYYB) sensors with a first exposure at a sensor frame rate; obtain one or more second image frames of the scene captured by the one or more RYYB sensors with a second exposure at the sensor frame rate, wherein the second exposure is lower than the first exposure; blend at least one color component of each image frame of the one or more first image frames with at least one color component of a respective adjacent second image frame of the one or more second image frames to produce one or more blended image frames; and generate at least one output frame comprising one or more color components from the one or more blended image frames and at least one additional color component from each image frame of the one or more first image frames.
Aspect 25. The apparatus of Aspect 24, wherein the at least one color component of each image frame of the one or more first image frames includes a first yellow color component and a first red color component of each image frame of the one or more first image frames, and wherein the at least one color component of the respective adjacent second image frame of the one or more second image frames includes a second yellow color component and a second red color component of the respective adjacent second image frame of the one or more second image frames.
Aspect 26. The apparatus of Aspect 25, wherein the one or more color components from the one or more blended image frames include at least one yellow color component and at least one red color component from the one or more blended image frames, and wherein the at least one additional color component from each image frame of the one or more first image frames includes a blue color component from each image frame of the one or more first image frames.
Aspect 27. The apparatus of Aspect 24, wherein the at least one color component of each image frame of the one or more first image frames includes a first blue color component of each image frame of the one or more first image frames, and wherein the at least one color component of the respective adjacent second image frame of the one or more second image frames includes a second blue color component of the respective adjacent second image frame of the one or more second image frames.
Aspect 28. The apparatus of Aspect 27, wherein the one or more color components from the one or more blended image frames include at least one blue color component from the one or more blended image frames, and wherein the at least one additional color component from each image frame of the one or more first image frames includes at least one yellow color component and at least one red color component from each image frame of the one or more first image frames.
Aspect 29. A method for processing one or more images, the method comprising: obtaining one or more first image frames of a scene captured by one or more red yellow blue (RYYB) sensors with a first exposure at a sensor frame rate; obtaining one or more second image frames of the scene captured by the one or more RYYB sensors with a second exposure at the sensor frame rate, wherein the second exposure is lower than the first exposure; blending at least one color component of each image frame of the one or more first image frames with at least one color component of a respective adjacent second image frame of the one or more second image frames to produce one or more blended image frames; and generating at least one output frame comprising one or more color components from the one or more blended image frames and at least one additional color component from each image frame of the one or more first image frames.
Aspect 30. The method of Aspect 29, wherein: the at least one color component of each image frame of the one or more first image frames includes a first yellow color component and a first red color component of each image frame of the one or more first image frames, and wherein the at least one color component of the respective adjacent second image frame of the one or more second image frames includes a second yellow color component and a second red color component of the respective adjacent second image frame of the one or more second image frames.
Aspect 31. The method of Aspect 30, wherein the one or more color components from the one or more blended image frames include at least one yellow color component and at least one red color component from the one or more blended image frames, and wherein the at least one additional color component from each image frame of the one or more first image frames includes a blue color component from each image frame of the one or more first image frames.
Aspect 32. The method of Aspect 29, wherein: the at least one color component of each image frame of the one or more first image frames includes a first blue color component of each image frame of the one or more first image frames, and wherein the at least one color component of the respective adjacent second image frame of the one or more second image frames includes a second blue color component of the respective adjacent second image frame of the one or more second image frames.
Aspect 33. The method of Aspect 32, wherein the one or more color components from the one or more blended image frames include at least one blue color component from the one or more blended image frames, and wherein the at least one additional color component from each image frame of the one or more first image frames includes at least one yellow color component and at least one red color component from each image frame of the one or more first image frames.
Aspect 34. A non-transitory computer-readable storage medium comprising instructions stored thereon which, when executed by at least one processor, causes the at least one processor to perform operations according to any of Aspects 29 to 33.
Aspect 35. An apparatus for processing one or more images, the apparatus including one or more means for performing operations according to any of Aspects 29 to 33.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for processing one or more images, the apparatus comprising:
at least one memory; and
at least one processor coupled to the at least one memory and configured to:
obtain one or more first image frames of a scene captured by one or more red green blue white (RGBW) sensors with a first exposure at a sensor frame rate;
obtain one or more second image frames of the scene captured by the one or more RGBW sensors with a second exposure at the sensor frame rate, wherein the second exposure is lower than the first exposure;
blend red green blue (RGB) components of each image frame of the one or more first image frames with RGB components of a respective adjacent second image frame of the one or more second image frames to produce one or more blended image frames; and
apply a white component of each image frame of the one or more second image frames to a respective blended image frame of the one or more blended image frames.

2. The apparatus of claim 1, wherein the one or more first image frames and the one or more second image frames are alternatively captured.

3. The apparatus of claim 2, wherein the one or more first image frames are an odd number of image frames captured by the one or more RGBW sensors, and the one or more second image frames are an even number of the image frames captured by the one or more RGBW sensors.

4. The apparatus of claim 1, wherein the at least one processor is configured to detect a bright light scenario for the scene based on at least one image frame of the scene exceeding a brightness threshold.

5. The apparatus of claim 4, wherein the brightness threshold is based on one or more parameters.

6. The apparatus of claim 5, wherein the one or more parameters are associated with at least one of automatic focus (AF), automatic white balance (AWB), or automatic exposure (AE).

7. The apparatus of claim 5, wherein the one or more parameters comprise a lux index.

8. The apparatus of claim 4, wherein the at least one processor is configured to adjust the sensor frame rate based on detecting the bright light scenario for the scene.

9. The apparatus of claim 1, wherein the at least one processor is configured to blend the RGB components of each frame of the one or more second image frames with RGB components of a respective adjacent first image frame of the one or more first image frames.

10. The apparatus of claim 1, wherein the at least one processor is configured to determine the second exposure based on one or more parameters associated with at least one of automatic focus (AF), automatic white balance (AWB), or automatic exposure (AE).

11. The apparatus of claim 1, wherein the at least one processor includes an image signal processor (ISP).

12. A method for image processing, the method comprising:
capturing, by one or more red green blue white (RGBW) sensors, one or more first image frames of a scene with a first exposure at a sensor frame rate;
capturing, by the one or more RGBW sensors, one or more second image frames of the scene with a second exposure at the sensor frame rate, wherein the second exposure is lower than the first exposure;
blending red green blue (RGB) components of each image frame of the one or more first image frames with RGB components of a respective adjacent second image frame of the one or more second image frames to produce one or more blended image frames; and
applying a white component of each image frame of the one or more second image frames to a respective blended image frame of the one or more blended image frames.

13. The method of claim 12, wherein the one or more first image frames and the one or more second image frames are alternatively captured.

14. The method of claim 13, wherein the one or more first image frames are an odd number of image frames captured by the one or more RGBW sensors, and the one or more second image frames are an even number of the image frames captured by the one or more RGBW sensors.

15. The method of claim 12, further comprising detecting a bright light scenario for the scene based on at least one image frame of the scene exceeding a brightness threshold.

16. The method of claim 15, wherein the brightness threshold is based on one or more parameters.

17. The method of claim 16, wherein the one or more parameters are associated with at least one of automatic focus (AF), automatic white balance (AWB), or automatic exposure (AE).

18. The method of claim 16, wherein the one or more parameters comprise a lux index.

19. The method of claim 15, further comprising adjusting the sensor frame rate based on detecting the bright light scenario for the scene.

20. The method of claim 12, further comprising blending the RGB components of each frame of the one or more second image frames with RGB components of a respective adjacent first image frame of the one or more first image frames.

21. The method of claim 12, further comprising determining the second exposure based on one or more parameters associated with at least one of automatic focus (AF), automatic white balance (AWB), or automatic exposure (AE).

22. A non-transitory computer-readable storage medium comprising instructions stored thereon which, when executed by at least one processor, causes the at least one processor to:
obtain one or more first image frames of a scene captured by one or more red green blue white (RGBW) sensors with a first exposure at a sensor frame rate;
obtain one or more second image frames of the scene captured by the one or more RGBW sensors with a second exposure at the sensor frame rate, wherein the second exposure is lower than the first exposure;
blend red green blue (RGB) components of each image frame of the one or more first image frames with RGB components of a respective adjacent second image frame of the one or more second image frames to produce one or more blended image frames; and
apply a white component of each image frame of the one or more second image frames to a respective blended image frame of the one or more blended image frames.

23. An apparatus for processing one or more images, the apparatus comprising:
at least one memory; and
at least one processor coupled to the at least one memory and configured to:
obtain one or more first image frames of a scene captured by one or more red yellow blue (RYYB) sensors with a first exposure at a sensor frame rate;
obtain one or more second image frames of the scene captured by the one or more RYYB sensors with a second exposure at the sensor frame rate, wherein the second exposure is lower than the first exposure;
blend at least one color component of each image frame of the one or more first image frames with at least one color component of a respective adjacent second image frame of the one or more second image frames to produce one or more blended image frames; and
generate at least one output frame comprising one or more color components from the one or more blended image frames and at least one additional color component from each image frame of the one or more first image frames.

24. The apparatus of claim 23, wherein the at least one color component of each image frame of the one or more first image frames includes a first yellow color component and a first red color component of each image frame of the one or more first image frames, and wherein the at least one color component of the respective adjacent second image frame of the one or more second image frames includes a second yellow color component and a second red color component of the respective adjacent second image frame of the one or more second image frames.

25. The apparatus of claim 24, wherein the one or more color components from the one or more blended image frames include at least one yellow color component and at least one red color component from the one or more blended image frames, and wherein the at least one additional color component from each image frame of the one or more first image frames includes a blue color component from each image frame of the one or more first image frames.

26. The apparatus of claim 23, wherein the at least one color component of each image frame of the one or more first image frames includes a first blue color component of each image frame of the one or more first image frames, and wherein the at least one color component of the respective adjacent second image frame of the one or more second image frames includes a second blue color component of the respective adjacent second image frame of the one or more second image frames.

27. The apparatus of claim 26, wherein the one or more color components from the one or more blended image frames include at least one blue color component from the one or more blended image frames, and wherein the at least one additional color component from each image frame of the one or more first image frames includes at least one yellow color component and at least one red color component from each image frame of the one or more first image frames.

28. A method for processing one or more images, the method comprising:
obtaining one or more first image frames of a scene captured by one or more red yellow blue (RYYB) sensors with a first exposure at a sensor frame rate;
obtaining one or more second image frames of the scene captured by the one or more RYYB sensors with a second exposure at the sensor frame rate, wherein the second exposure is lower than the first exposure;
blending at least one color component of each image frame of the one or more first image frames with at least one color component of a respective adjacent second image frame of the one or more second image frames to produce one or more blended image frames; and
generating at least one output frame comprising one or more color components from the one or more blended image frames and at least one additional color component from each image frame of the one or more first image frames.

29. The method of claim 28, wherein:
the at least one color component of each image frame of the one or more first image frames includes a first yellow color component and a first red color component of each image frame of the one or more first image frames, and wherein the at least one color component of the respective adjacent second image frame of the one or more second image frames includes a second yellow color component and a second red color component of the respective adjacent second image frame of the one or more second image frames; and
the one or more color components from the one or more blended image frames include at least one yellow color component and at least one red color component from the one or more blended image frames, and wherein the at least one additional color component from each image frame of the one or more first image frames includes a blue color component from each image frame of the one or more first image frames.

30. The method of claim 28, wherein:
the at least one color component of each image frame of the one or more first image frames includes a first blue color component of each image frame of the one or more first image frames, and wherein the at least one color component of the respective adjacent second image frame of the one or more second image frames includes a second blue color component of the respective adjacent second image frame of the one or more second image frames; and
the one or more color components from the one or more blended image frames include at least one blue color component from the one or more blended image frames, and wherein the at least one additional color component from each image frame of the one or more first image frames includes at least one yellow color component and at least one red color component from each image frame of the one or more first image frames.
